(19) United States
(12) Patent Application Publication
(10) Pub. No.: US 2014/0332244 A1
(43) Pub. Date: Nov. 13, 2014

(54) ENCLOSURE FOR A POWER CELL OF A HYDRAULIC HAMMER

(71) Applicant: Caterpillar Inc., Peoria, IL (US)

(72) Inventors: Cody Moore, Waco, TX (US); Jayaram Gunasekaran, Chennai (IN); Colins Jacob, Bangalore (IN); Arun Palanoor, Bangalore (IN)

(73) Assignee: Caterpillar Inc., Peoria, IL (US)

(21) Appl. No.: 14/445,114

(22) Filed: Jul. 29, 2014

(51) Int. Cl. B25D 17/00; B25D 9/00

(52) U.S. Cl. CPC B25D 17/00; B25D 9/00
USPC 173/90

(57) ABSTRACT

An enclosure for a power cell of a hydraulic hammer includes a single-piece hollow elongated body, a resilient cover, and multiple deformable plugs. The body includes a top flange, and an integrally formed polyhedral mid-portion. The mid-portion includes multiple sidewalls, and an end wall that is integral with a bottom end of the sidewalls. The sidewalls define a first sealing aperture, a second sealing aperture, and a pair of arcuate openings thereon. The resilient cover includes laterally disposed first and second portions that are configured to releasably engage with the body to cover a top portion and a bottom portion of the arcuate opening respectively. The deformable plugs are releasably engaged with the body at the first and second sealing apertures. The plugs include resilient members that co-operate with interfitting features located adjacent to the first and second sealing apertures of the body.

### TECHNICAL FIELD

The present disclosure generally relates to an enclosure. More particularly, the present disclosure relates to an enclosure for housing a power cell of a hydraulic hammer

### BACKGROUND

Typically, enclosures for a power hammer are made from casting a metal alloy into several pieces and assembling such individually casted pieces in an assembly line. For reference, U.S. Publication No. 2002/0190092 discloses a method for manufacturing a protective cover for a breaking apparatus. The protective cover is formed from two elongated cover parts having a substantially L-shaped cross section; wherein the longitudinal edge portions of the cover parts are arranged together, thus forming a tubular structure having a rectangular cross section.

The configuration of such piece-wise manufacturing and assembly processes may require several complexities to be factored in forming the enclosure. The complexities may vary depending on the type of hydraulic hammer, and/or specific requirements of an application in which the hydraulic hammer is used. Moreover, some of the complexities may be intrinsic to the manufacturing and assembly processes itself and may additionally depend on design constraints of the hydraulic hammer.

The complexities typically encountered in piece-wise casting of the enclosure and assembly thereof may include dimensioning of the molds required to cast each component; providing tolerances in the molds corresponding to each of the components; locating pins, cores, and gates in the molds corresponding to holes and/or other interfitting features in the structure of the enclosure. Moreover, some of the holes and/or other interfitting features from adjacently positioned components in the enclosure may need to register with one another, and hence, require precision in the alignment of the pins, cores, and gates provided in the molds. Therefore, the piece-wise casting of components may be expensive. Moreover, the assembly of such individually cast components with one another to form the enclosure may be expensive besides being tedious or laborious to a manufacturer.

Hence, there is a need for a cost-effective yet simplified structure of the enclosure that overcomes the aforementioned shortcomings Additionally, there is a need for a cost-effective yet simplified method of producing such an enclosure.

### SUMMARY OF THE DISCLOSURE

In an aspect of the present disclosure, an enclosure for housing a power cell of a hydraulic hammer includes a single-piece hollow elongated body that is formed from casting. The body includes a top flange that defines a central opening, and a plurality of apertures located about the central opening. The central opening is configured to receive the power cell therethrough. The apertures are configured to receive one or more fasteners therein and allow attachment of the top flange with an adjacent higher assembly.

The enclosure further includes a polyhedral mid-portion that is integrally formed with the top flange. The polyhedral mid-portion includes a plurality of sidewalls that are configured to depend downwardly from the top flange. Each of the sidewalls includes an upper portion and a lower portion, wherein an area enclosed between the lower portions of the sidewalls is less than an area enclosed between the upper portions of the sidewalls.

Moreover, the polyhedral mid-portion includes an end wall that is integrally formed with and located at a bottom end of the sidewalls. The end wall defines a recess that is disposed in communication with the central opening of the top flange. The recess is configured to allow insertion of a pecking tool at least partway therethrough.

Further, the lower portion of at least one sidewall defines a first sealing aperture, and a second sealing aperture. The first sealing aperture is disposed in a lateral relation to the recess. The first sealing aperture is configured to allow access to a locking pin associated with the pecking tool. The second sealing aperture is located above the first sealing aperture. The second sealing aperture is configured to allow access to the power cell. Additionally, the upper portion of at least one pair of mutually opposing sidewalls defines a pair of arcuate openings thereon, the arcuate openings being disposed adjacent to an underside of the top flange.

The enclosure further includes a resilient cover that is releasably engaged with the hollow elongated body and disposed within the pair of arcuate openings. The resilient cover includes a first portion that is configured to cover a top portion of the arcuate opening. The first portion defines a plurality of incised members that are configured to flexibly allow insertion of a hose for coupling with the power cell.

The resilient cover further includes a second portion that is laterally disposed to the first portion and also depends downwardly therefrom. The second portion is configured to flexibly cover a bottom portion of the arcuate opening and allow access to at least one of the hose and the power cell.

The enclosure further includes a plurality of deformable plugs that are disposed in releasable engagement with the hollow elongated body. Each of the plugs is located at the first sealing aperture and the second sealing aperture respectively. Each of the plugs includes one or more resilient members. These resilient members are configured to co-operate with interfitting features that are defined by the hollow elongated body and located adjacent to the first and second sealing apertures.

Other features and aspects of this disclosure will be apparent from the following description and the accompanying drawings.

### BRIEF DESCRIPTION OF THE DRAWINGS

FIG. 1 is a diagrammatic view of an exemplary machine using a hydraulic hammer in accordance with an embodiment of the present disclosure;

FIG. 2 is a diagrammatic view of the hydraulic hammer in accordance with an embodiment of the present disclosure, the diagrammatic view presenting the hydraulic hammer in an exploded configuration and an assembled configuration;

FIG. 3 is a front sectional view of the hydraulic hammer taken from the embodiment of FIG. 2;

FIG. 4 is a side perspective view of a resilient cover that can be used to cover an arcuate opening defined in a body of the hydraulic hammer;

FIG. 5 is a side perspective view of a deformable plug that can be releasably engaged with a sealing aperture defined in the body of the hydraulic hammer taken from FIG. 2;

FIG. 6 is a diagrammatic view of the hydraulic hammer in accordance with another embodiment of the present disclosure, the diagrammatic view presenting the hydraulic hammer in an exploded configuration and an assembled configuration;

FIG. 7 is a front sectional view of the hydraulic hammer taken from the embodiment of FIG. 6; and

FIG. 8 is a side perspective view of a resilient cover that can be used to cover an arcuate opening defined in a body of the hydraulic hammer taken from FIG. 6.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

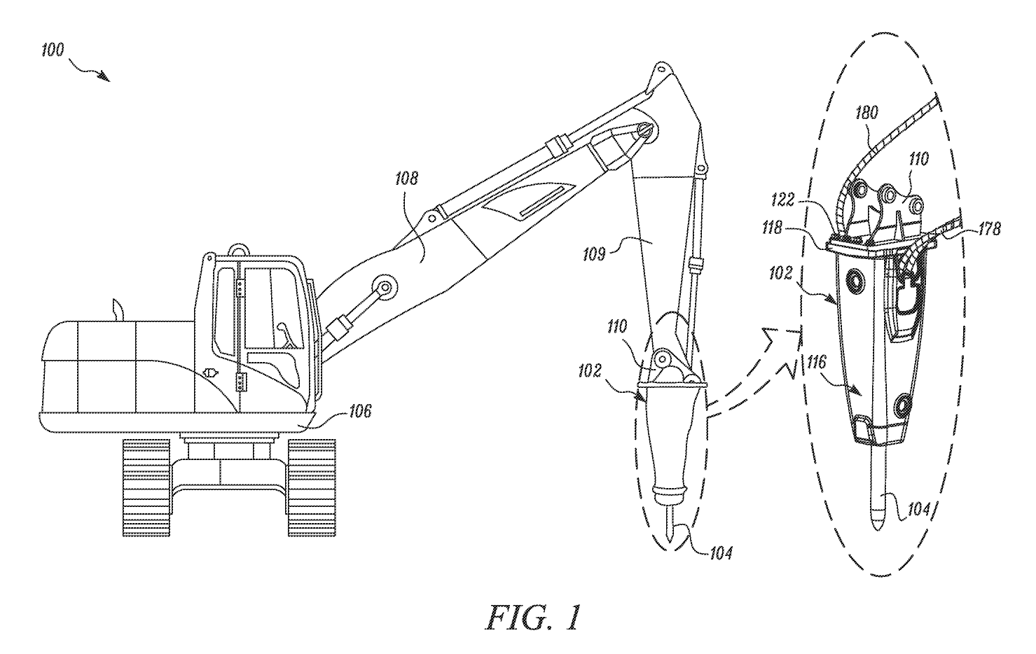

FIG. 1 shows a diagrammatic view of an exemplary machine 100. The machine 100 employs a hydraulic hammer 102 shown in accordance with an embodiment of the present disclosure. The hydraulic hammer 102 includes a pecking tool 104 that is configured to break rocks and drill ground surfaces.

In the illustrated embodiment of FIG. 1, the machine 100 is embodied in the form of a tracked industrial vehicle such as an excavator, wherein the hydraulic hammer 102 is mounted to replace an excavator bucket (not shown) previously associated with the excavator. Consequently, the hydraulic hammer 102 is operated by the excavator's hydraulics. However, it may be contemplated to use other types of machines and carriers to power the hydraulic hammer 102 of the present disclosure.

As shown in FIG. 1, the machine 100 includes a frame 106; one or more linkages 108, 109; and a pivoting bracket 110 that pivotally connects the hydraulic hammer 102 to the linkage 109. The linkages 108, 109 may be articulated relative to the frame 106 in order to change an orientation and/or position of the hydraulic hammer 102 with respect to a ground surface.

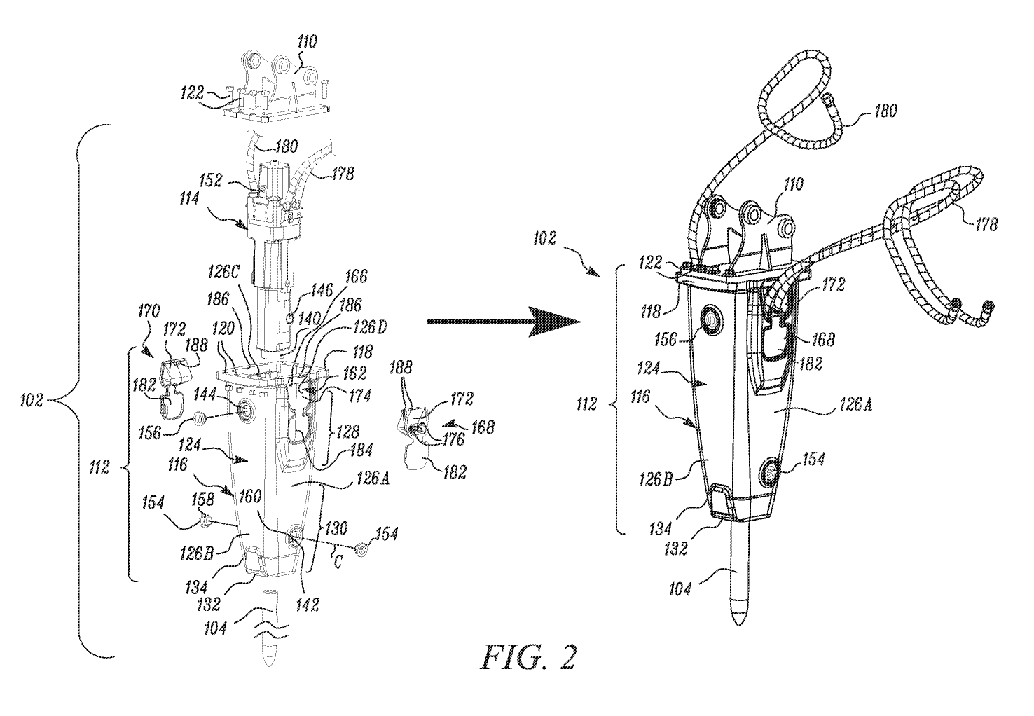

Referring to FIG. 2, a diagrammatic view of the hydraulic hammer 102 is rendered showing the hydraulic hammer 102 in an exploded configuration and an assembled configuration respectively. The hydraulic hammer 102 includes an enclosure 112 configured to house a power cell 114 therein. The power cell 114 is configured to drive the pecking tool 104 of the hydraulic hammer 102 so that the pecking tool 104 may perform functions that are consistent with the present disclosure.

As shown, the enclosure 112 includes a single-piece hollow elongated body 116 (hereinafter simply referred to as ‘body’ and designated by the same numeral ‘116’) that is formed from casting. The body 116 includes a top flange 118 that defines a central opening, and a plurality of apertures 120 located about the central opening. The central opening is configured to receive the power cell 114 therethrough. The apertures 120 are configured to receive one or more fasteners 122 therein so as to allow attachment of the body 116 with the pivoting bracket 110.

The body 116 further includes a polyhedral mid-portion 124 (hereinafter simply referred to as ‘mid-portion’ and designated by the same reference numeral ‘124’) that is integrally formed with the top flange 118. The polyhedral mid-portion 124 includes a plurality of sidewalls 126 (four sidewalls shown in the embodiment of FIG. 2 and individually designated by alpha-numerals ‘126A’, 126A, ‘126B’, ‘126C’, and ‘126D’ respectively) that are configured to depend downwardly from the top flange 118.

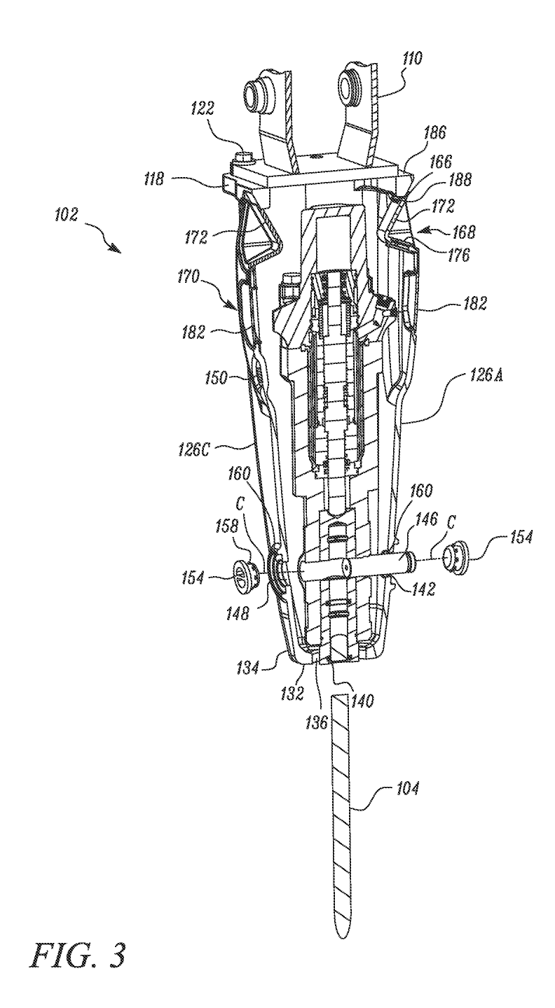

Referring to FIGS. 2 and 3, each of the sidewalls 126A, 126B, 126C, and 126D includes an upper portion 128 and a lower portion 130, wherein an area enclosed between the lower portions 130 of the sidewalls 126A, 126B, 126C, and 126D is less than an area enclosed between the upper portions 128 of the sidewalls 126A, 126B, 126C, and 126D. Moreover, as shown in FIG. 3, the polyhedral mid-portion 124 includes an end wall 132 that is integrally formed with a bottom end 134 of the sidewalls 126A, 126B, 126C, and 126D. The end wall 132 defines a recess 136 that is disposed in communication with the central opening of the top flange 118. The recess 136 is configured to allow insertion of the pecking tool 104 at least partway therethrough. The pecking tool 104 inserted through the recess 136 of the end wall 132 can therefore be received within a bottom portion 140 of the power cell 114.

With continued reference to FIGS. 2 and 3, the lower portion 130 of at least one of the sidewalls 126A, 126B, 126C, and 126D defines a first sealing aperture 142, and a second sealing aperture 144. The first sealing aperture 142 is disposed in a lateral relation to the recess 136. The first sealing aperture 142 is configured to allow access to a locking pin 146 associated with the pecking tool 104. As such, the locking pin 146 is inserted along a centric axis of the first sealing aperture 142 after insertion of the pecking tool 104 into the bottom portion 140 of the power cell 114. In this manner, the locking pin 146 secures the pecking tool 104 to the power cell 114 and allows the pecking tool 104 to co-operate with the power cell 114 during operation of the hydraulic hammer 102.

The second sealing aperture 144 is located above the first sealing aperture 142. The second sealing aperture 144 is configured to allow access to the power cell 114. Specifically, the second sealing aperture 144 is configured to allow access to a low pressure nitrogen (N2) port 152 provided on the power cell 114.

Although one first sealing aperture 142 and one second sealing aperture 144 is disclosed herein, it should be noted that a number of sealing apertures is non-limiting of this disclosure. In the illustrated embodiment of FIGS. 2 and 3, another first sealing aperture 148 is provided on the sidewall 126C so as to allow a bi-directional access to the locking pin 146. One of the two first sealing apertures 142, 148 can be used to insert the locking pin 146 for locking a position of the pecking tool 104 while another first sealing aperture 142, 148 (not shown in the diagrammatic view of FIG. 2, See FIG. 3) can be used to insert a hand-operated tool, for e.g., a chisel (not shown), that can be struck by an impact delivering tool, for e.g., a hammer (not shown), to accomplish removal of the locking pin 146.

Similarly, with continued reference to FIGS. 2 and 3, another second sealing aperture 150 (hidden in the view of FIG. 2, visible in FIG. 3) is provided on the sidewall 126C. Such second sealing aperture can be beneficially configured to allow access to a high pressure nitrogen (N2) port (not shown) provided on the power cell 114. Therefore, one of ordinary skill in the art can beneficially contemplate to provide any number of first and second sealing apertures without deviating from the scope of present disclosure as defined by the appended claims.

Referring to FIG. 2, the enclosure 112 further includes a plurality of deformable plugs 154, 156 that are disposed in releasable engagement with the hollow elongated body 116. Four plugs 154, 156 are shown illustrated in the embodiment of FIG. 2, in which two plugs 154 (both plugs designated with numeral ‘154’) correspond with the first sealing apertures 142, 148 and two plugs 156 (both plugs designated with numeral ‘156’) correspond with the second sealing apertures 144 (one second sealing aperture hidden in the view of FIG. 2)). Explanation to the deformable plugs 154, 156 will however be rendered in conjunction with the first sealing aperture 142 and the second sealing aperture 144 located at sidewalls 126A, 126B). However, such explanation can be similarly understood as being applicable to the other deformable plugs corresponding to the other sealing apertures disclosed herein.

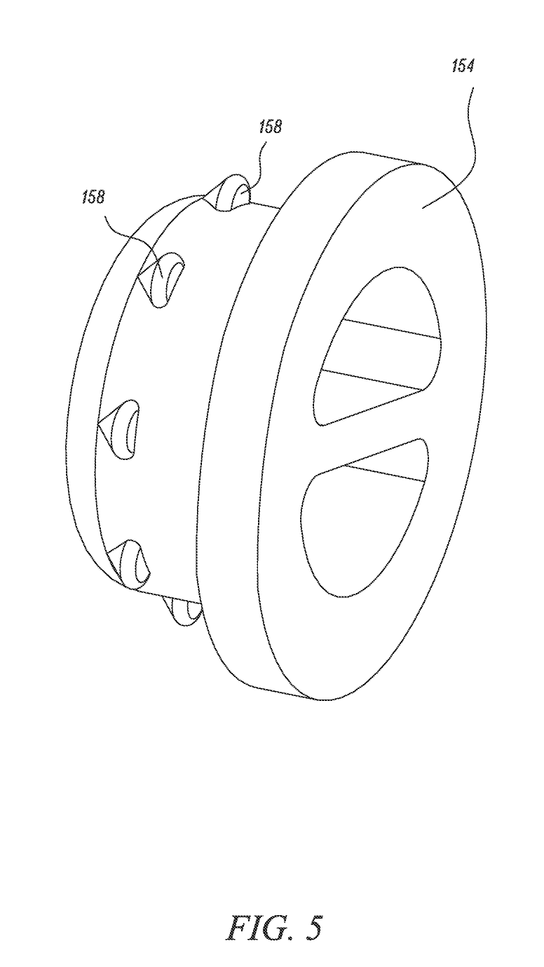

At least two plugs 154, 156 are provided to be co-located with the first sealing aperture 142 and the second sealing aperture 144 respectively, i.e., the first sealing aperture 142 and the second sealing aperture 144 located at sidewalls 126A, 126B. Each of the two plugs 154, 156 includes one or more resilient members 158 (See FIGS. 2 and 5). These resilient members 158 are configured to co-operate with interfitting features 160 that are defined by the hollow elongated body 116 and located adjacent to the first and second sealing apertures 142, 148, and 144.

The plugs 154, 156, disclosed herein, may be configured to have similar or dissimilar sizes depending on the sizes of the associated apertures 142, 148, and 144. However, it can be beneficially contemplated to form the first and second sealing apertures 142, 148, and 144 to substantially similar sizes so that the plugs 154, 156 can be made to a uniform size. Such a configuration may allow manufacturers of hydraulic hammers to accomplish an interchangeable fitment of the plugs 154, 156 onto the apertures 142, 148, and 144 without much concern. Moreover, it is envisioned that such similar sizing of the plugs 154, 156 can allow manufacturers to employ less tooling and hence, entail less manufacturing costs in producing the similarly sized plugs 154, 156.

Additionally, the upper portion 128 of at least one pair of mutually opposing sidewalls 126 (in this case, sidewalls 126A and 126C) defines a pair of arcuate openings 162 thereon (only one arcuate opening 162 visible in the view of FIG. 2). Although explanation will be made in conjunction with the arcuate opening 162, such explanation should be understood as being similarly applicable to the arcuate opening provided on sidewall 126C). The arcuate openings 162 are disposed adjacent to an underside 166 of the top flange 118.

The enclosure 112 further includes two resilient covers 168, 170 (one cover for each arcuate opening). As shown, the resilient cover 168 is releasably engaged with the hollow elongated body 116 and disposed within the arcuate opening 162. The resilient covers 168, 170, disclosed herein, are made from an elastomeric material such as rubber, but are not limited thereto. One of ordinary skill in the art will acknowledge that it can be contemplated to optionally use other suitable materials in lieu of rubber disclosed herein.

Explanation pertaining to the resilient cover 168 and the arcuate opening 162 associated with the sidewall 126A will be made hereinafter. However, it should be noted that such explanation is similarly applicable to the arcuate opening and the resilient cover 170 associated with the sidewall 126C, unless specified otherwise in this document.

Referring to FIGS. 2, 3, and 4, the resilient cover 168 includes a first portion 172 that is configured to cover a top portion 174 of the arcuate opening 162. The first portion 172 defines a plurality of incised members 176 that are configured to flexibly allow insertion of a hose 178 therethrough and for allowing a coupling of the hose 178 with a port of the power cell 114.

The hose 178 together with the port is configured to allow fluid communication between the power cell 114 and the hydraulics of the machine 100. Such fluid communication between the hydraulics of the machine 100 and the power cell 114 may facilitate operation of the power cell 114 and operatively drive the pecking tool 104.

With reference to embodiments of the present disclosure, it is hereby contemplated to locate the arcuate opening 162 and the resilient cover 168 on the sidewall 126A such that upon receiving the power cell 114 within the body 116 of the enclosure 112, the arcuate opening 162 and the resilient cover 168 are beneficially located adjacent to the port of the power cell 114. The port, disclosed herein, may be a outlet port of the power cell 114 out of which fluid may be flown to the hydraulics of the machine 100.

Similarly, the arcuate opening and the resilient cover 170 associated with the sidewall 126C may be located to beneficially face a supply port of the power cell 114 (not visible in the front perspective view of FIG. 2). The first portion 172 of the resilient cover 170 is similarly configured to include incised members 176 to allow a hose 180 to connect with the supply port (not shown) of the power cell 114. Such hose 180 and supply port disclosed herein may be configured to allow fluid to egress in to the power cell 114 from the hydraulics of the machine 100.

Additionally, it can be contemplated to vary the number of incised members 176 on the first portion 172 depending on the number of ports on the power cell 114 and hence, the number of hoses that correspond to the ports on the power cell 114. For example, it may be possible to have more than one supply port or more than one outlet port on the power cell 114 and hence, the covers 168, 170 associated with the respective ports can be beneficially formed to include such corresponding number of incised members 176 so as to allow insertion of the required number of hoses.

The resilient cover 168 further includes a second portion 182 that is laterally disposed to the first portion 172. The second portion 182 is further configured to depend downwardly from the first portion 172 of the resilient cover 168 and flexibly cover a bottom portion 184 of the arcuate opening 162. The second portion 182 of the resilient cover 168 is provided to allow access to the hose 178 and the power cell 114. As such, by locating the bottom portion 184 of the arcuate opening 162 and the resilient cover 168 to be adjacently positioned to the port of the power cell 114, the hose 178 and the outlet port of the power cell 114 may be easily accessed by a technician or an operator of the machine 100.

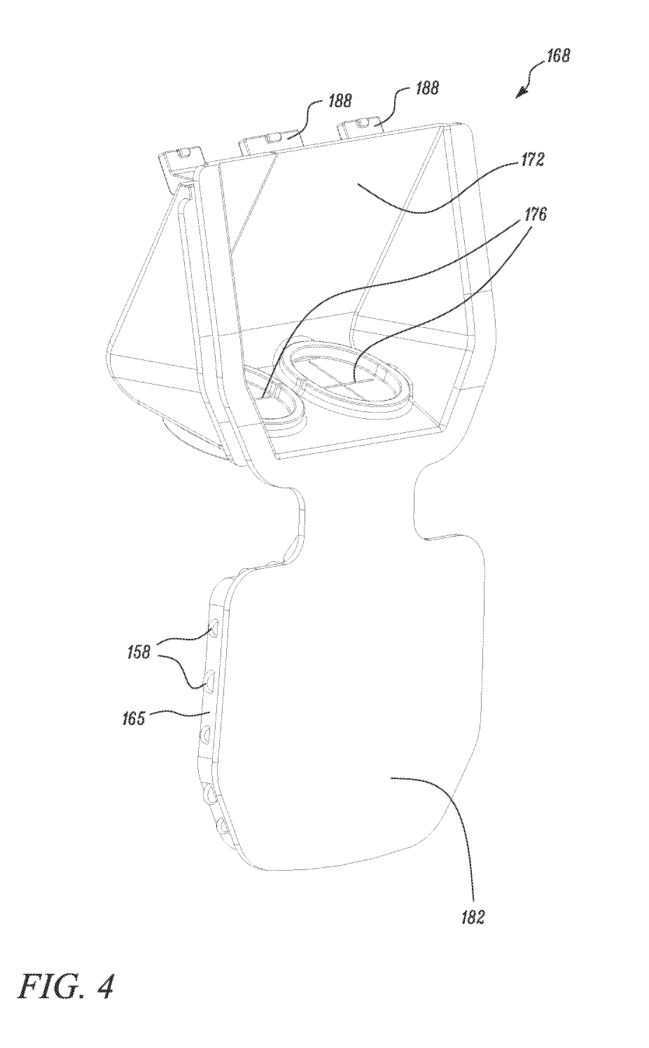

Optionally or additionally, in an embodiment as shown in FIG. 4, such resilient members 158 may be formed on a periphery 165 of the second portion 182 of the resilient cover 168 so that such resilient members 158 may help the second portion 182 of the cover 168 to releasably engage with the sidewall 126A of the body 116.

It should be noted that as the cover 168 is made from an elastomeric material, some degree of flexibility is imparted to the cover 168 to allow movement of the first and/or the second portions 172, 182 relative to each other. Hence, in order to access the hose 178 and/or the port of the power cell 114, the technician or an operator may merely flex the second portion 182 relative to the first portion 172 so as to dispose the second portion 182 outward of the body 116 while the first portion 172 of the resilient cover 168 continues to remain engaged to the body 116.

As shown in the embodiment of FIG. 2, the top flange 118 is contiguous so as to define an intermediate portion 186 adjoining the arcuate opening 162 and the arcuate opening provided on sidewall 126C. The underside 166 of the top flange 118 lying adjacent to the intermediate portion 186 i.e., the underside 166 of the top flange 118 that is adjoining the arcuate opening 162 may be configured to releasably engage with one or more snap members 188 extending from the first portion 172 of the resilient cover 168 (See also FIG. 3). Any number of snap members may be suitably included in the first portion 172 of the resilient cover 168 to accomplish a releasable engagement with the body 116.

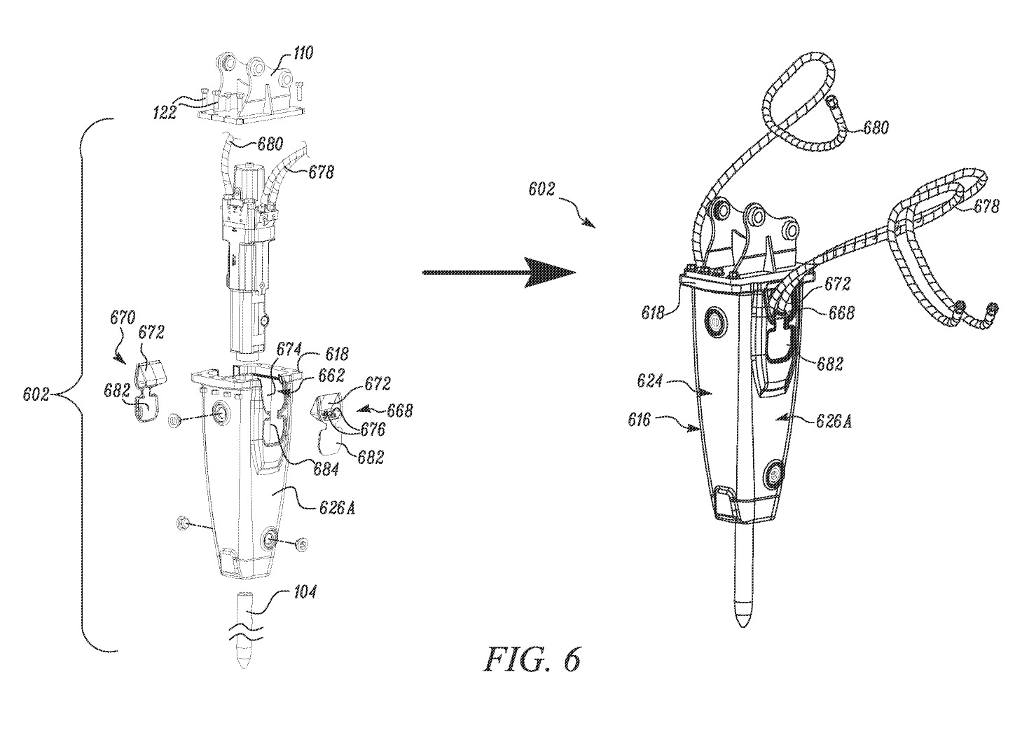

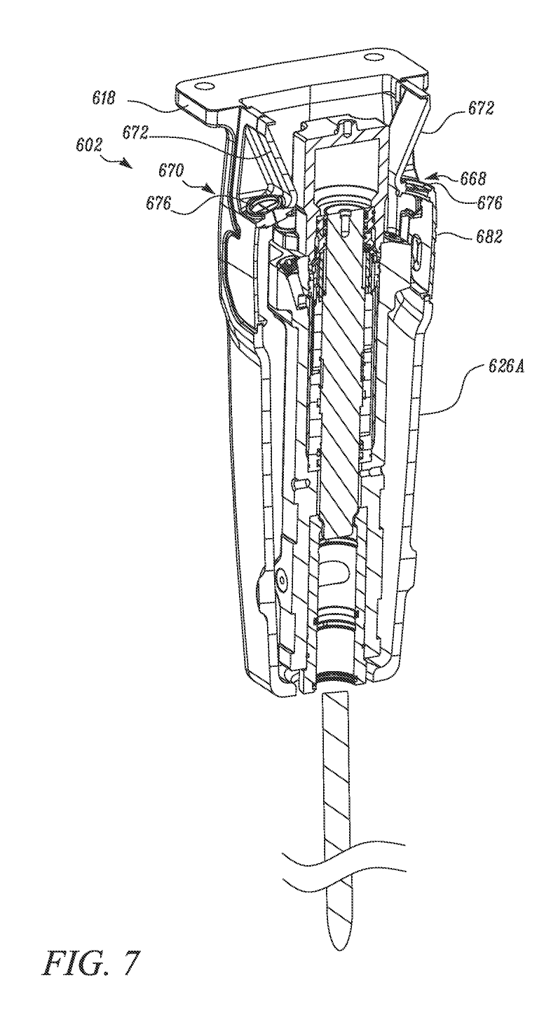

A hydraulic hammer 602 in accordance with another embodiment of the present disclosure is illustrated in FIGS. 6-7. Moreover, explanation pertaining to the hydraulic hammer 602 of the present disclosure will be made in conjunction with FIGS. 6-7 of the accompanying drawings. Reference to elements that are similar between the hydraulic hammer 102 of FIGS. 2, 3, and 4; and the hydraulic hammer 602 of FIGS. 6-7 will be made with similar numerals/alpha-numerals increased by 500.

Referring to FIGS. 6 and 7, the enclosure 612 has a top flange 618 that is discontinuous to present a two-part top flange, i.e., the top flange 618 is absent or omitted from being located above the pair of arcuate openings 662, 664. In this embodiment, the enclosure 612 includes a resilient cover (two covers 668, 670 shown corresponding to the pair of arcuate openings 662, 664). The resilient covers 668, 670 are releasably engaged with the hollow elongated body 616 and disposed within the pair of arcuate openings 662, 664.

Referring to FIGS. 6, 7, and 8, the resilient cover 668 includes a first portion 672, and a second portion 682. The second portion 682 is laterally disposed and depending downwardly from the first portion 672. The first portion 672 is configured to cover a top portion 674 of the arcuate opening 662 while the second portion 682 is configured to flexibly cover a bottom portion 684 of the arcuate opening 662. The first portion 672 defines a plurality of incised members 14-1013 676 that are configured to flexibly allow insertion of the hose 678 for coupling with the power cell 614. The second portion 682 is configured to allow access to at least one of the hose 678 and the power cell 614.

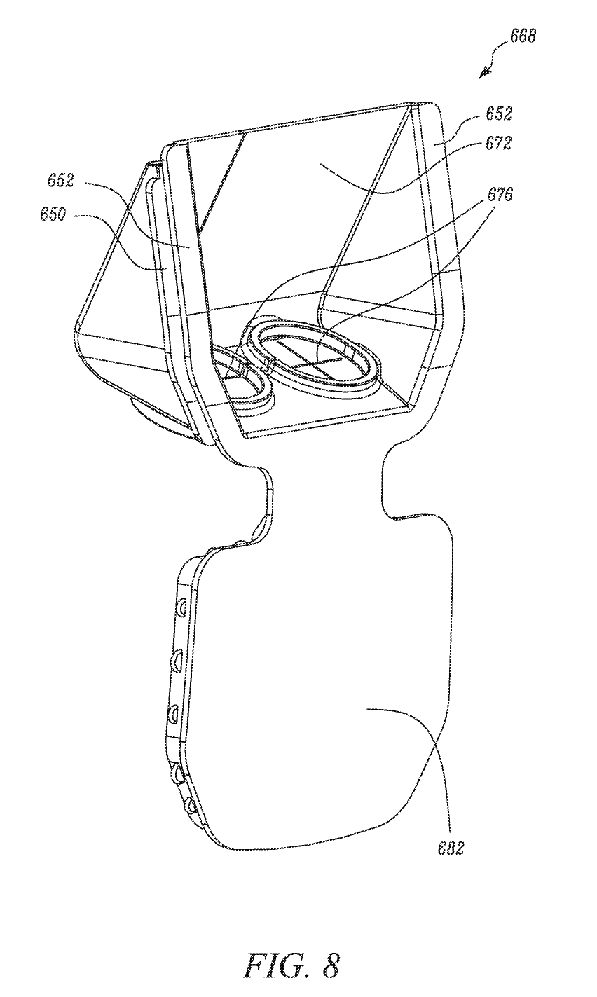

With continued reference to FIGS. 6, 7, and 8, as the top flange 618 is discontinuous at locations above the pair of arcuate openings 662, 664, the first portion 672 of the resilient cover 668 includes a groove member 650 disposed at lateral ends 652 thereof (See FIG. 8). These groove members 650 are configured to engage with the sidewall 626A of the body 116 adjoining the top portion 674 of the arcuate opening 662. The groove members 650 therefore establish a joint with the sidewall 626A that may be regarded as being analogous to a tongue-and-groove joint.

Various embodiments disclosed herein are to be taken in the illustrative and explanatory sense, and should in no way be construed as unduly limiting of the present disclosure. All directional references (e.g., above, below, upper, lower, top, bottom, vertical, horizontal, inward, outward, radial, upward, downward, left, right, leftward, rightward, clockwise, and counter-clockwise) are only used for identification purposes to aid the reader's understanding of the present disclosure, and may not create limitations, particularly as to the position, orientation, or use of the systems and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The enclosure 112 of the present disclosure has applicability for use and implementation in housing a power cell 114 of a hydraulic hammer 102.

More specifically, the enclosure 112 of the present disclosure employs a single-piece body 116 that is obtained from casting. Such unitary configuration of the body 116 allows manufacturers to do away with use of multiple molds previously required to cast a housing of a hydraulic hammer Also, various complexities associated with use of multiple molds, for example, dimensioning of the molds; providing tolerances in the molds; and accurately locating pins, cores, and gates in the molds corresponding to holes and/or other interfitting features in the structure of the enclosure may be avoided.

With use of embodiments disclosed herein, manufacturers may quickly and easily produce the single-piece hollow elongated body 116 while also accomplishing an economical production or manufacturing process line. Moreover, manufacturers may easily and quickly assembly the resilient covers 168, 170 and the deformable plugs 154, 156 of the present disclosure onto the hollow elongated body 116 thereby reducing time typically required for assembly of previously known multi-piece bodies or housings. Therefore, the present disclosure allows manufacturers of hydraulic hammers to produce a simplified yet cost-effective enclosure that is quick to produce, while also being easy and quick to assemble.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. An enclosure for housing a power cell of a hydraulic hammer, the enclosure comprising:
a single-piece hollow elongated body formed from casting, the body including:
a top flange defining:
a central opening configured to receive the power cell therethrough; and
a plurality of apertures located about the central opening, the apertures configured to receive one or more fasteners therein;
a polyhedral mid-portion integrally formed with the top flange, the polyhedral mid-portion including:
a plurality of sidewalls configured to depend downwardly from the top flange, each of the sidewalls including:
an upper portion and a lower portion, wherein an area enclosed between the lower portions of the sidewalls is less than an area enclosed between the upper portions of the sidewalls; and
an end wall integrally formed with and located at a bottom end of the sidewalls, the end wall defining a recess disposed in communication with the central opening of the top flange, the end wall configured to allow insertion of a pecking tool at least partway therethrough, wherein:
the lower portion of at least one sidewall defines:
a first sealing aperture disposed in lateral relation to the recess, the first sealing aperture configured to allow access to a locking pin associated with the pecking tool, and
a second sealing aperture located above the first sealing aperture, the second sealing aperture configured to allow access to the power cell, and wherein
the upper portion of at least one pair of mutually opposing sidewalls defines a pair of arcuate openings thereon, the pair of arcuate openings disposed adjacent to an underside of the top flange, and
a resilient cover releasably engaged with the hollow elongated body and disposed within the pair of arcuate openings, the resilient cover including:
a first portion configured to cover a top portion of the arcuate opening, the first portion further defining a plurality of incised members that are configured to flexibly allow insertion of a hose for coupling with the power cell; and
a second portion laterally disposed and depending downwardly from the first portion, the second portion configured to flexibly cover a bottom portion of the arcuate opening and allow access to at least one of the hose and the power cell; and
a plurality of deformable plugs, wherein each of the plugs is disposed in releasable engagement with the hollow elongated body and located at the first sealing aperture and the second sealing aperture respectively, the plugs including resilient members configured to co-operate with interfitting features that are defined by the hollow elongated body adjacent to the first and second sealing apertures.
